(19) United States
(12) Patent Application Publication
(10) Pub. No.: US 2023/0002611 A1
(43) Pub. Date: Jan. 5, 2023

(54) THERMOSETTING RESIN MATERIAL, PREPREG, AND METAL SUBSTRATE

(71) Applicant: NAN YA PLASTICS CORPORATION, Taipei (TW)

(72) Inventors: TE-CHAO LIAO, TAIPEI (TW); HUNG-YI CHANG, TAIPEI (TW); CHIEN-KAI WEI, TAIPEI (TW)

(21) Appl. No.: 17/560,177

(22) Filed: Dec. 22, 2021

(30) Foreign Application Priority Data
Jun. 30, 2021 (TW) 110123920

(51) Int. Cl. C08L 75/04; C08J 5/24; B32B 5/02; B32B 15/14

(52) U.S. Cl. CPC C08L 75/04; C08J 5/24; B32B 5/024; B32B 15/14; C08L 2205/03; C08L 2203/30; C08J 2375/04; C08J 2471/12; C08J 2479/08; B32B 2260/021; B32B 2260/046; B32B 2307/204; B32B 2307/748; B32B 2264/1021; B32B 2264/1022

(57) ABSTRACT

A thermosetting resin material, a prepreg, and a metal substrate are provided. The thermosetting resin material includes a resin composition and inorganic fillers. The resin composition includes: 10 wt % to 30 wt % of a polyphenylene ether resin, 40 wt % to 60 wt % of a cyanate resin, and 20 wt % to 40 wt % of a bismaleimide resin. The inorganic fillers undergo a surface modification process to have at least one of an acryl group and an ethylene group.

### CROSS-REFERENCE TO RELATED PATENT APPLICATION

This application claims the benefit of priority to Taiwan Patent Application No. 110123920, filed on Jun. 30, 2021. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a thermosetting resin material, a prepreg, and a metal substrate, and more particularly to a thermosetting resin material, a prepreg, and a metal substrate that have a good thermal resistance.

### BACKGROUND OF THE DISCLOSURE

A thermosetting resin material has a cross-linkable structure. After being cured, the thermosetting resin material can form a three-dimensional network structure. Accordingly, the thermosetting resin material shows a high thermal resistance and stable dimensions, such that the thermosetting resin material can be widely applied in the field of electronic equipment.

The thermosetting resin material usually includes a cyanate compound that is used as the cross-linkable structure. The cyanate compound has a high flame retardant property and a high glass transition temperature. However, the cyanate compound has a low thermal resistance and high dielectric properties (e.g., dielectric constant and dielectric loss). Specifically, a metal substrate formed from the conventional thermosetting resin material has a dielectric constant higher than 3.7 and a dielectric loss higher than 0.004.

Therefore, how to improve the thermal resistance and the dielectric properties of the thermosetting resin material by adjusting the composition of the thermosetting resin material has become one of the important issues to be solved in the related art.

### SUMMARY OF THE DISCLOSURE

In response to the above-referenced technical inadequacies, the present disclosure provides a thermosetting resin material, a prepreg, and a metal substrate.

In one aspect, the present disclosure provides a thermosetting resin material. The thermosetting resin material includes a resin composition and inorganic fillers. The resin composition includes: 10 wt % to 30 wt % of a polyphenylene ether resin, 40 wt % to 60 wt % of a cyanate resin, and 20 wt % to 40 wt % of a bismaleimide resin. The inorganic fillers are processed by a surface modification process to have at least one of an acryl group and an ethylene group.

In certain embodiments, based on a total weight of the thermosetting resin material being 100 wt %, an amount of the inorganic fillers ranges from 40 wt % to 70 wt %.

In certain embodiments, the inorganic fillers include silicon dioxide or a combination of silicon dioxide and titanium dioxide.

In certain embodiments, the titanium dioxide is rutile titanium dioxide.

In certain embodiments, the bismaleimide resin has a structure of formula (I) below:

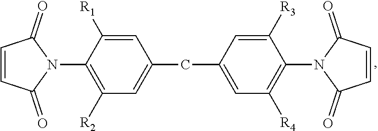

in which R₁, R₂, R₃, and R₄ are each an alkyl group having 1 to 5 carbon atoms.

In certain embodiments, R₁ and R₃ are methyl groups, and R₂ and R₄ are ethyl groups.

In certain embodiments, the cyanate resin has two or more than two of cyanate groups.

In another aspect, the present disclosure provides a thermosetting resin material. The thermosetting resin material includes a resin composition, inorganic fillers, and a silane coupling agent. The silane coupling agent includes at least one of methacryl-based silane and acryl-based silane. The resin composition includes: 10 wt % to 30 wt % of a polyphenylene ether resin, 40 wt % to 60 wt % of a cyanate resin, and 20 wt % to 40 wt % of a bismaleimide resin.

In certain embodiments, based on a total weight of the thermosetting resin material being 100 wt %, an amount of the inorganic fillers ranges from 40 wt % to 70 wt %.

In certain embodiments, the inorganic fillers include silicon dioxide or a combination of silicon dioxide and titanium dioxide.

In certain embodiments, the titanium dioxide is rutile titanium dioxide.

In certain embodiments, the bismaleimide resin has a structure of formula (I) below:

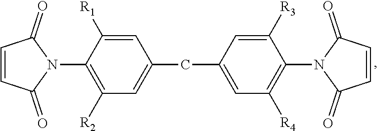

in which R₁, R₂, R₃, and R₄ are each an alkyl group having 1 to 5 carbon atoms.

In certain embodiments, R₁ and R₃ are methyl groups, and R₂ and R₄ are ethyl groups.

In certain embodiments, the cyanate resin has two or more than two cyanate groups.

In yet another aspect, the present disclosure provides a prepreg. The prepreg is formed by immersing a reinforcing material into the above-mentioned thermosetting resin material.

In still another aspect, the present disclosure provides a metal substrate. The metal substrate includes a substrate layer and a metal layer disposed on the substrate layer. The substrate layer is formed from the above-mentioned prepreg.

In certain embodiments, a glass transition temperature of the metal substrate ranges from 250° C. to 280° C.

In certain embodiments, a dielectric constant of the metal substrate ranges from 3.35 to 3.80.

In certain embodiments, a dielectric loss of the metal substrate is lower than or equal to 0.0044.

In certain embodiments, a peeling strength of the metal substrate ranges from 5.0 lb/in to 6.0 lb/in.

Therefore, in the thermosetting resin material, the prepreg, and the metal substrate provided by the present disclosure, by virtue of “the inorganic fillers undergoing the surface modification process to have at least one of the acryl group and the ethylene group” or “the thermosetting material including the silane coupling agent, and the silane coupling agent including at least one of the methacryl-based silane and the acryl-based silane”, thermal resistance and dielectric properties of the metal substrate can be enhanced.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a side view of a metal substrate of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

In order to solve problems of low thermal resistance and high dielectric properties of a conventional thermosetting resin material, the present disclosure provides a thermosetting resin material, a prepreg, and a metal substrate. The thermosetting resin material of the present disclosure includes a resin composition, inorganic fillers, a flame retardant, a hardener, and a hardening initiator. The inorganic fillers, the flame retardant, the hardener, and the hardening initiator are uniformly dispersed in the resin composition. It should be noted that the inorganic fillers in the present disclosure are processed by a surface modification process to have at least one of an acryl group and an ethylene group. Or, the inorganic fillers are mixed with a silane coupling agent (at least one of a methacryl-based silane and an acryl-based silane), so that the inorganic fillers undergo the surface modification process.

### Resin Composition

The resin composition of the present disclosure includes: 10 wt % to 30 wt % of a polyethylene ether resin, 40 wt % to 60 wt % of a cyanate resin, and 20 wt % to 40 wt % of a bismaleimide resin. By adjusting the composition of the resin composition according to the above ranges, the resin composition of the present disclosure can not only have a good thermal resistance and good dielectric properties, but can also have an appropriate glass transition temperature and an appropriate peeling strength.

In the present disclosure, a weight-average molecular weight (Mw) of the polyethylene ether resin ranges from 100 g/mol to 6000 g/mol. Preferably, the weight-average molecular weight of the polyethylene ether resin ranges from 300 g/mol to 5000 g/mol. More preferably, the weight-average molecular weight of the polyethylene ether resin ranges from 400 g/mol to 2500 g/mol. When the weight-average molecular weight of the polyethylene ether resin is within the above range, the polyethylene ether resin has a high solubility in a solvent, which is beneficial for the preparation of the thermosetting resin material.

In some embodiments, the polyethylene ether resin can have a modified group. The modified group is selected from the group consisting of: a hydroxyl group, an amino group, an ethylene group, a styrene group, a methacryl group, and an epoxy group. The modified group of the polyethylene ether resin provides an unsaturated group for a crosslinking reaction, so as to obtain a material that has a high glass transition temperature (Tg) and a good thermal resistance. In the present embodiment, the polyethylene ether resin has two modified groups respectively at two opposite molecular ends, and the two modified groups are the same. In an exemplary embodiment, the modified group on the polyethylene ether resin is a methacryl group or a styrene group.

The polyethylene ether resin can include more than one kind of polyethylene ether resin. For example, the polyethylene ether resin includes a first polyethylene ether resin and a second polyethylene ether resin. The first polyethylene ether resin and the second polyethylene ether resin both have at least one modified group at the molecular end. The modified group is selected from the group consisting of: a hydroxyl group, an amino group, an ethylene group, a styrene group, a methacryl group, and an epoxy group. In addition, the modified group of the first polyethylene ether resin and the modified group of the second polyethylene ether resin are different from each other.

In the present disclosure, a weight-average molecular weight of the cyanate resin ranges from 100 g/mol to 7000 g/mol. Preferably, the weight-average molecular weight of the cyanate resin ranges from 100 g/mol to 5000 g/mol. More preferably, the weight-average molecular weight of the cyanate resin ranges from 100 g/mol to 3000 g/mol. A viscosity of the cyanate resin at 25° C. ranges from 425 mPa·s to 475 mPa·s. When the weight-average molecular weight or the viscosity of the cyanate resin is within the above range, a crosslinking property of the resin composition can be enhanced without negatively influencing a viscosity and processability of the overall resin composition. Such a configuration is beneficial for subsequent applications of the thermosetting resin material.

In some embodiments, the cyanate resin includes one or more than one kind of compound or polymer that contains a cyanate group. Preferably, an average quantity of the cyanate groups contained in the cyanate resin is two or more than two. More preferably, the cyanate resin is a symmetrical structure. In other words, the cyanate resin can be represented as NCO—R—OCN. For example, the cyanate resin can be a bisphenol A cyanate resin, but is not limited thereto.

In the present disclosure, a weight-average molecular weight of the bismaleimide resin ranges from 100 g/mol to 1000 g/mol. Preferably, the weight-average molecular weight of the bismaleimide resin ranges from 100 g/mol to 800 g/mol. More preferably, the weight-average molecular weight of the bismaleimide resin ranges from 200 g/mol to 500 g/mol. An addition of the bismaleimide resin can enhance a glass transition temperature and processability of the thermosetting resin material.

In some embodiments, a main structure of the bismaleimide resin includes bisphenol A, so as to terminate a maleimide resin. The bisphenol A of the main structure is branched by an alkyl group having 1 to 5 carbon atoms. Specifically, a structure of the bismaleimide resin is represented by formula (I) below.

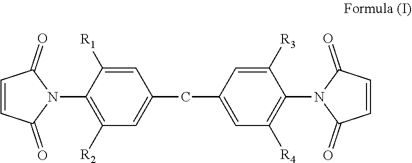

In formula (I), R₁, R₂, R₃, and R₄ are each an alkyl group having 1 to 5 carbon atoms. Preferably, R₁, R₂, R₃, and R₄ are each an alkyl group having 1 to 3 carbon atoms. In an exemplary embodiment, R₁ and R₃ are methyl groups, and R₂ and R₄ are ethyl groups. However, the present disclosure is not limited thereto.

### Inorganic Fillers

Based on a total weight of the thermosetting resin material being 100 wt %, an amount of the inorganic fillers ranges from 40 wt % to 70 wt %. An addition of the inorganic fillers can decrease the viscosity of the resin composition and enhance a mechanical strength of the resin composition. In addition, the addition of the inorganic fillers can decrease the dielectric constant and the dielectric loss of the thermosetting resin material.

In the present disclosure, the inorganic fillers can optionally undergo a surface modification process in advance, so as to form at least one of an acryl group and an ethylene group on a surface of the inorganic fillers. Or, the inorganic fillers can optionally be mixed with a silane coupling agent for the surface modification process, so as to form a silane treatment layer on the surface of the inorganic fillers. The silane coupling agent is at least one of the methacryl-based silane and the acryl-based silane.

In some embodiments, the inorganic fillers at least include silicon dioxide, and can optionally further include titanium dioxide. In other words, the inorganic fillers can include silicon dioxide or a combination of silicon dioxide and titanium dioxide. In an exemplary embodiment, the inorganic fillers include a combination of silicon dioxide and titanium dioxide, and the titanium dioxide is rutile titanium dioxide.

### Flame Retardant

Based on a total weight of the resin composition being 100 parts per hundred resin (phr), an amount of the flame retardant ranges from 5 phr to 15 phr. An addition of the flame retardant can enhance a flame retardant property of the thermosetting resin material. The flame retardant can be, for example, a phosphorus flame retardant or a bromine flame retardant. The phosphorus flame retardant can be, for example, sulphosuccinic acid ester, phosphazene, ammonium polyphosphate, melamine polyphosphate, melamine cyanurate, or any combination thereof, but is not limited thereto. The bromine flame retardant can be, for example, ethylene bistetrabromophthalimide, tetradecabromodiphenoxy benzene, decabromo diphenoxy oxide, or any combination thereof, but is not limited thereto.

### Hardener and Hardening Initiator

Based on a total weight of the resin composition being 100 phr, an amount of the hardener ranges from 0.05 phr to 1.5 phr, and an amount of the hardening initiator ranges from 0.05 phr to 1.5 phr. An addition of the hardener and the hardening initiator can assist the thermosetting resin material to be cured.

The hardener can be imidazole, such as: triphenylimidazole, 2-ethyl-4-methylimidazole (2E4MZ), 1-benzyl-2-phenylimidazole (1B2PZ), 1-cyanoethyl-2-phenylimidazole (2PZ-CN), or 2,3-dihydro-1H-pyrrole[1,2-a]benzimidazole (TBZ). However, the present disclosure is not limited thereto.

The hardening initiator can be peroxide, such as: tert-butyl cumyl peroxide, dicumyl peroxide (DCP), benzoyl peroxide (BPO), 2,5-dimethyl-2,5-di(tert-butylperoxy)hexane, 2,5-dimethyl-2,5-di(tert-butylperoxy)hexyne, 1,1-di-(tert-butylperoxy)-3,3,5-trimethylcyclohexane, or di(tert-butylperoxyisopropyl)benzene. However, the present disclosure is not limited thereto.

The present disclosure provides a prepreg. A method for manufacturing the prepreg includes: preparing the above-mentioned thermosetting resin material, immersing a fiber fabric into the thermosetting resin material, and drying the immersed fiber fabric to form the prepreg. For example, the fiber fabric can be woven from glass fibers, carbon fibers, KEVLAR® fibers, polyester fibers, quartz fibers, or any combination thereof. However, the present disclosure is not limited thereto.

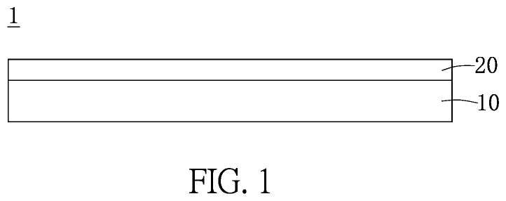

Referring to FIG. 1, the present disclosure provides a metal substrate 1. The metal substrate 1 includes a substrate layer 10 and a metal layer 20 disposed on the substrate layer 10. The substrate layer 10 is formed from the aforesaid prepreg through processing. The metal layer 20 is formed by having a metal foil disposed onto the substrate layer 10 and then heat-pressing the metal foil and the substrate layer 10. Specifically, a heat-pressing temperature of the metal substrate ranges from 180° C. to 260° C., a heat-pressing pressure ranges from 15 kg/cm² to 55 kg/cm², and a heat-pressing duration ranges from 2 hours to 4 hours. However, the present disclosure is not limited thereto.

In order to prove that the thermosetting resin material of the present disclosure has a good thermal resistance and good dielectric properties, the inorganic fillers, the flame retardant, the hardener, and the hardening initiator are uniformly dispersed into the resin composition to form the thermosetting resin material. Subsequently, the substrate layer 10 is formed from the thermosetting resin material according to the method mentioned previously, and then the metal layer 20 is disposed onto the substrate layer 10, so as to obtain the metal substrate 1.

According to Table 1, a polyethylene ether resin 1 is a polyethylene ether resin that has two styrene groups respectively at two molecular ends, and a polyethylene ether resin 2 is a polyethylene ether resin that has two methacryl groups respectively at two molecular ends. The cyanate resin is a phenolic cyanate ester. A bismaleimide resin 1 is represented by formula (II), a bismaleimide resin 2 is represented by formula (III), and a bismaleimide resin 3 is represented by formula (IV).

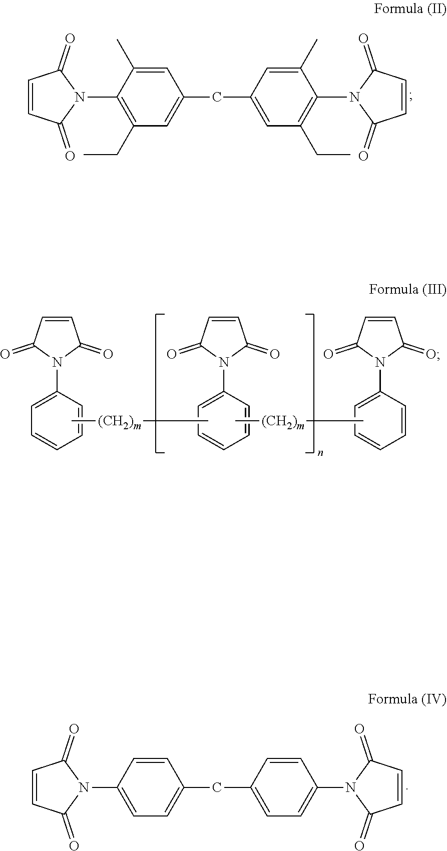

TABLE 1

| | | Example | | | | | | Comparative Example | | | | |
|---|---|---|---|---|---|---|---|---|---|---|---|---|
| (parts per hundred resin) | | 1 | 2 | 3 | 4 | 5 | 6 | 1 | 2 | 3 | 4 | 5 |
| Resin | Polyethylene ether resin 1 | 0 | 11 | 0 | 0 | 0 | 0 | 0 | 0 | 0 | 0 | 0 |
| composition | Polyethylene ether resin 2 | 11 | 0 | 11 | 11 | 11 | 11 | 11 | 11 | 11 | 11 | 11 |
| | Cyanate resin | 19 | 19 | 19 | 19 | 19 | 19 | 19 | 19 | 19 | 19 | 19 |
| | Bismaleimide resin 1 | 8 | 8 | 8 | 8 | 8 | 8 | 0 | 0 | 8 | 8 | 8 |
| | Bismaleimide resin 2 | 0 | 0 | 0 | 0 | 0 | 0 | 8 | 0 | 0 | 0 | 0 |
| | Bismaleimide resin 3 | 0 | 0 | 0 | 0 | 0 | 0 | 0 | 8 | 0 | 0 | 0 |
| Inorganic | Unmodified SiO₂ | 60 | 60 | 55 | 0 | 0 | 0 | 60 | 60 | 55 | 60 | 60 |
| fillers | Methacryl group modified | 0 | 0 | 0 | 0 | 0 | 55 | 0 | 0 | 0 | 0 | 0 |
| | SiO₂ | | | | | | | | | | | |
| | Acryl group modified SiO₂ | 0 | 0 | 0 | 60 | 0 | 0 | 0 | 0 | 0 | 0 | 0 |
| | Ethylene group modified SiO₂ | 0 | 0 | 0 | 0 | 60 | 0 | 0 | 0 | 0 | 0 | 0 |
| | Anatase TiO₂ | 0 | 0 | 0 | 0 | 0 | 0 | 0 | 0 | 5 | 0 | 0 |
| | Rutile TiO₂ | 0 | 0 | 5 | 0 | 0 | 5 | 0 | 0 | 0 | 0 | 0 |
| Silane | Acryl-based silane | 1 | 1 | 1 | 0 | 0 | 0 | 1 | 1 | 1 | 0 | 0 |
| coupling | Ethylene-based silane | 0 | 0 | 0 | 0 | 0 | 0 | 0 | 0 | 0 | 1 | 0 |
| agent | Epoxy-based silane | 0 | 0 | 0 | 0 | 0 | 0 | 0 | 0 | 0 | 0 | 1 |
| Properties | Glass transition | 271 | 271 | 269 | 268 | 258 | 263 | 255 | 250 | 253 | 260 | 265 |
| of metal | temperature (° C.) | | | | | | | | | | | |
| substrate | Dielectric constant | 3.56 | 3.51 | 3.75 | 3.48 | 3.42 | 3.62 | 3.44 | 3.43 | 3.45 | 3.42 | 3.47 |
| | (at 10 GHz) | | | | | | | | | | | |
| | Dielectric loss × 10³ | 3.9 | 3.9 | 3.7 | 3.9 | 3.7 | 4.3 | 4.5 | 4.5 | 4.4 | 4.2 | 4.4 |
| | (at 10 GHz) | | | | | | | | | | | |
| | Peeling strength (lb/in) | 5.8 | 5.4 | 5.45 | 5.2 | 5.5 | 5.6 | 5 | 5.1 | 5.2 | 5.5 | 5.9 |
| | Thermal resistance | OK | OK | OK | OK | OK | OK | OK | OK | NG | NG | NG |

According to Table 1, the thermosetting resin material of the present disclosure not only has a good thermal resistance and low dielectric constant and dielectric loss, but also maintains an appropriate glass transition temperature and an appropriate peeling strength. Specifically, the glass transition temperature of the metal substrate ranges from 250° C. to 280° C., the dielectric constant of the metal substrate ranges from 3.35 to 3.80, the dielectric loss of the metal substrate is lower than or equal to 0.0044, and the peeling strength of the peeling metal substrate ranges from 5.0 lb/in to 6.0 lb/in.

In Examples 1 to 3 and 6, the inorganic fillers are mixed with the silane coupling agent for the surface modification process, so as to form a silane layer on the surface of the inorganic fillers. In Examples 4 and 5, the inorganic fillers undergo the surface modification process in advance, so that an acryl group or an ethylene group is formed on the surface of the inorganic fillers. In other words, the metal substrate formed from the thermosetting resin material of the present disclosure can have a good thermal resistance and good dielectric properties by using the inorganic fillers that have undergone the surface modification process.

According to Example 1 and Comparative Examples 1 and 2, compared to the bismaleimide resins 2 and 3, the addition of the bismaleimide resin 1 can increase the glass transition temperature of the metal substrate, decrease the dielectric loss of the metal substrate, and enhance the peeling strength of the metal substrate.

According to Example 3 and Comparative Example 3, compared to anatase titanium dioxide, using of the rutile titanium dioxide can increase the glass transition temperature of the metal substrate, decrease the dielectric loss of the metal substrate, and enhance the peeling strength of the metal substrate.

According to Examples 1 and 6 and Comparative Examples 4 and 5, compared to the ethylene-based silane and the epoxy-based silane, when the inorganic fillers are treated by the acryl-based silane or the methacryl-based silane for the surface modification process, the glass transition temperature of the metal substrate can be increased and the dielectric loss of the metal substrate can be decreased.

### Beneficial Effects of the Embodiment

In conclusion, in the thermosetting resin material, the prepreg, and the metal substrate provided by the present disclosure, by virtue of “the inorganic fillers undergoing the surface modification process to have at least one of the acryl group and the ethylene group” or “the thermosetting material including a silane coupling agent, and the silane coupling agent including at least one of the methacryl-based silane and the acryl-based silane”, the thermal resistance and the dielectric properties of the metal substrate can be enhanced.

Further, by virtue of “the titanium dioxide being the rutile titanium dioxide”, the glass transition temperature and the peeling strength of the metal substrate can be enhanced, and the dielectric loss of the metal substrate can be decreased.

Further, by virtue of “the bismaleimide resin having the structure of formula (I) below:

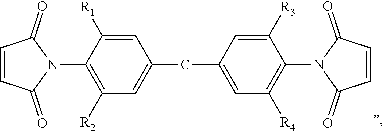

the glass transition temperature and the peeling strength of the metal substrate can be enhanced, and the dielectric loss of the metal substrate can be decreased.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated.

Alternative embodiments will become apparent to those skilled in the art to which the present disclosure pertains without departing from its spirit and scope.

What is claimed is:

1. A thermosetting resin material, comprising a resin composition and inorganic fillers, wherein the resin composition includes:
10 wt % to 30 wt % of a polyphenylene ether resin;
40 wt % to 60 wt % of a cyanate resin; and
20 wt % to 40 wt % of a bismaleimide resin;
wherein the inorganic fillers undergo a surface modification process to have at least one of an acryl group and an ethylene group.

2. The thermosetting resin material according to claim 1, wherein, based on a total weight of the thermosetting resin material being 100 wt %, an amount of the inorganic fillers ranges from 40 wt % to 70 wt %.

3. The thermosetting resin material according to claim 1, wherein the inorganic fillers include silicon dioxide or a combination of silicon dioxide and titanium dioxide.

4. The thermosetting resin material according to claim 3, wherein the titanium dioxide is rutile titanium dioxide.

5. The thermosetting resin material according to claim 1, wherein the bismaleimide resin has a structure of formula (I) below: 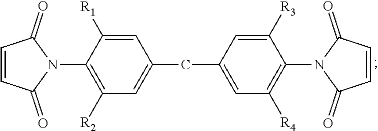
wherein R₁, R₂, R₃, and R₄ are each an alkyl group having 1 to 5 carbon atoms.

6. The thermosetting resin material according to claim 5, wherein R₁ and R₃ are methyl groups, and R₂ and R₄ are ethyl groups.

7. The thermosetting resin material according to claim 1, wherein the cyanate resin has two or more than two of cyanate groups.

8. A thermosetting resin material, comprising a resin composition, inorganic fillers, and a silane coupling agent, wherein the silane coupling agent includes at least one of a methacryl-based silane and an acryl-based silane, and the resin composition includes:
10 wt % to 30 wt % of a polyphenylene ether resin;
40 wt % to 60 wt % of a cyanate resin; and
20 wt % to 40 wt % of a bismaleimide resin.

9. The thermosetting resin material according to claim 8, wherein, based on a total weight of the thermosetting resin material being 100 wt %, an amount of the inorganic fillers ranges from 40 wt % to 70 wt %.

10. The thermosetting resin material according to claim 8, wherein the inorganic fillers include silicon dioxide or a combination of silicon dioxide and titanium dioxide.

11. The thermosetting resin material according to claim 8, wherein the titanium dioxide is rutile titanium dioxide.

12. The thermosetting resin material according to claim 8, wherein the bismaleimide resin has a structure of formula (I) below: 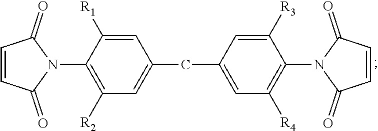
wherein R₁, R₂, R₃, and R₄ are each an alkyl group having 1 to 5 carbon atoms.

13. The thermosetting resin material according to claim 12, wherein R₁ and R₃ are methyl groups, and R₂ and R₄ are ethyl groups.

14. The thermosetting resin material according to claim 8, wherein the cyanate resin has two or more than two of cyanate groups.

15. A prepreg formed by immersing a reinforcing material into the thermosetting resin material as claimed in claim 1.

16. A metal substrate, comprising a substrate layer and a metal layer disposed on the substrate layer, wherein the substrate layer is formed from the prepreg as claimed in claim 15.

17. The metal substrate according to claim 16, wherein a glass transition temperature of the metal substrate ranges from 250° C. to 280° C.

18. The thermosetting resin material according to claim 16, wherein a dielectric constant of the metal substrate ranges from 3.35 to 3.80.

19. The thermosetting resin material according to claim 16, wherein a dielectric loss of the metal substrate is lower than or equal to 0.0044.

20. The thermosetting resin material according to claim 16, wherein a peeling strength of the metal substrate ranges from 5.0 lb/in to 6.0 lb/in.
